(19) United States
(12) Patent Application Publication
(10) Pub. No.: US 2024/0430244 A1
(43) Pub. Date: Dec. 26, 2024

(54) SYSTEM AND METHODS FOR AUTHENTICATED SECURE SESSION KEY ESTABLISHMENT FOR PROTECTING A COMMUNICATION BETWEEN NODES IN A COMMUNICATION NETWORK

(71) Applicant: SWISSBIT AG, Bronschhofen (CH)

(72) Inventors: Osman UGUS, Olching (DE); Zeren LU, Germering (DE)

(21) Appl. No.: 18/750,896

(22) Filed: Jun. 21, 2024

(30) Foreign Application Priority Data
Jun. 23, 2023 (DE) 10 2023 116 545.3

(51) Int. Cl. H04L 9/40; H04L 67/146

(52) U.S. Cl. CPC H04L 63/062; H04L 67/146

(57) ABSTRACT

Method and system for to establishing session keys for protecting communication between nodes in a communication network. A mutual authentication is performed between a responding device and a trusted authentication service. Parameters used in the authentication are shared with one or more initiating nodes, clients, that are allowed to communicate with the responding device if authentication was successful. A secure session key is created independently by the device and clients using authentication parameters and pre-shared keys. Session keys created can be used to protect subsequent actual data communication. The described solution is not tied to any specific underlying transport protocol.

### CROSS-REERENCE TO RELATED APPLICATION

This application claims the benefit of German Patent Application No. 10 2023 116 545.3 filed Jun. 23, 2023, the entire contents of which are incorporated herein by reference in its entirety.

The present invention relates to the field of cryptography. Specifically, the invention is directed to a system and methods for establishing one or more cryptographic session keys for protecting a communication between nodes, such as end points, in a communication network, such as in one-to-one communication or one-to-many communication scenarios.

A brief overview of various technologies in the field is provided below for reference:

Kerberos [1] is a technology for providing a distributed network authentication service. The primary goal of the basic Kerberos protocol is to enable a server (D) to authenticate a client (C) before granting it for accessing its applications and services. Additionally, a shared key is established between C and D as a side effect. In Kerberos, D and C share no secret keys. Instead, a trusted third-party authentication service (AS) shares a secret key both with D and C.

The Kerberos protocol proceeds as follows: C requests from AS for credentials for D. AS responds with a session key encrypted for C and a ticket encrypted for D. C transmits the ticket containing C's identity and a session key to D. The session key is used by D to authenticate C. Further options available include a final message for mutually authenticating D by C and the establishment of an additional sub-session key between C and D not chosen by AS. Extensions of Kerberos using public key cryptography or other methods during certain phases of the authentication protocol exist.

A problem with Kerberos is that there is no direct message exchange between D and AS, and D's authenticity is not verified by AS explicitly. AS has no direct way to prevent clients from communicating with an unauthenticated D. Clients can re-use already issued tickets by creating new Kerberos authenticators.

Another problem with Kerberos is that it requires a strict secure time synchronization between involving entities to identify expired authenticators and tickets. Providing a secure time synchronization might be a challenging task in certain use cases.

Finally, group key establishment is not specified in Kerberos.

Multimedia Internet KEYing (MIKEY) [2] is another technology, which describes a key management scheme that can be used for real-time applications. A traffic-encrypting Key (TEK), derived from a TEK generation key (TGK), is used as input for protecting the actual data traffic between end points. MIKEY defines three methods that can be used for establishing a TGK between peers: pre-shared key method, public-key encryption method, and Diffie-Hellman (DH) key agreement method. In the first two methods, the Initiator of the key management protocol generates and pushes a TGK to corresponding Responders.

A problem with MIKEY's pre-shared key method is that individual keys need to be shared between each Initiator and Responder for protecting MIKEY messages containing the TGK. This leads to scalability problems when the number of peers grows and makes the pre-shared key method insufficient for groups with large number of receivers.

In MIKEY's public-key encryption method, MIKEY messages are protected using a random envelope key (instead of pre-shared keys) chosen by the Initiator. The Initiator sends the envelope key to the Responder encrypted with the public key of the Responder within the initial MIKEY message. Hence, the public-key encryption method offers better scalability compared to the pre-shared key method. However, this method has a problem in that it is more resource-consuming than the pre-shared key approach and that it requires a PKI.

The Diffie-Hellman (DH) key agreement method is yet another technology, in which the TGK is not generated by the Initiator and subsequently pushed to the Responder. Instead, the TGK is negotiated between the Initiator and Responder using the DH key exchange protocol. Important problems with the DH key agreement method include that it cannot be used for creating group keys and that it requires a PKI.

MIKEY-DHHMAC [3] is a MIKEY extension describing a light-weight variant of the DH key agreement method. Consequently, this extension is also unsuitable for creating group keys.

MIKEY-RSA-R [4] defines another extension, called MIKEY-RSA in Reverse mode, in which the Responder is allowed to choose the TGK instead of the Initiator (In contrast, TGK is generated by the Initiator and pushed to the Responder in public-key method of MIKEY [2]). This makes MIKEY-RSA-133 R more suitable for using in certain communication scenarios like a conferencing scenario. However, the problem with MIKEY-RSA-R is that it inherits the disadvantages of the public-key encryption method defined in [2].

MIKEY-IBAKE [5] method is a variant of MIKEY relying on a trusted key management service (KMS). An Identity-Based Authenticated Key Exchange (IBAKE) framework is used to perform a mutual authentication between an Initiator and Responder. Session keys are derived in an asymmetric Identity-Based Encryption (IBE) framework. KMS in the MIKEY-IBAKE method is a low-availability server that communicates with its users periodically (e.g., once a month). A main problem of MIKEY-IBAKE is that it supports no group key distribution and has high resource consumption.

The MIKEY-SAKKE [6] scheme, also relying on a trusted KMS, defines a MIKEY key exchange extension using Identity-based Public Key Cryptography (IDPKC) to establish a shared secret value and certificateless signatures to provide source authentication. Similar to MIKEY-IBAKE, this scheme does not require the KMS to offer high availability. Rather, it needs only distribute new keys to its users periodically. MIKEY-SAKKE scheme has a high resource consumption, which is a problem of this method.

MIKEY-TICKET is described in [7]. It combines a trusted KMS with a ticket concept similar to that in Kerberos. Tickets are used to identify and deliver the keys and hence, they need to be protected. MIKEY-TICKET method describes four modes. Each mode differs from another depending on whether the Initiator or Responder or both have to contact with KMS to request or resolve tickets. The mode “4” describes the scenario in which the key protecting the ticket is shared between the Initiator and the Responder. No KMS assistance is required in this mode, and it can be seen as a variation of the pre-shared key method of MIKEY [2] with its scalability problems when the number of peers grows. In the first three modes (Mode “1”, Mode “2”, and Mode “3”), KMS assistance is required for generating and/or resolving the tickets. Hence, KMSs are requested to be high-availability online servers.

A problem with all MIKEY methods described above (except the MIKEY-RSA-R [4]) is that a good random number generator (RNG) must be available at the Initiator. Use of bad RNGs makes all of them prone to different kinds of attacks (p.47 in [7], p.53 in [2]). Hence, for a secure operation, all MIKEY methods above assume availability of a good RNG at Initiators and KMSs when involved. However, this assumption may not be always realistic or satisfied. For example, Initiators may not be equipped with a good RNG in use cases where multiple devices taking the role of Initiators for transmitting or receiving data to/from a central component taking the role of a Responder. The reason for this limitation might be a technical one, or financial, or both. Such limitations are likely to be faced with, when the role of Initiators is taken by resource-constrained devices (e.g. IoT sensor and actuator devices). In such scenarios, the number of peers, taking the role of a Responder, is likely to be fewer than the number of peers taking the role of Initiators. Hence, the assumption that Responders and KMSs can be equipped with a good RNG may be considered as a realistic assumption.

It is an object of the present invention to provide an improved system and method for establishing one or more cryptographic session keys for protecting a communication between nodes, such as end points, in a communication network, such improved systems and methods addressing at least one of the problems identified above.

A solution to this objective is provided by the teaching of the independent claims. Various preferred embodiments of the present solution are provided by the teachings of the dependent claims.

### Terms

Some terms used herein to define the present solution are explained below in more detail:

The terms “first”, “second”, “third” and the like in the description and in the claims, are used for distinguishing between similar elements and not necessarily for describing a sequential or chronological order. It is to be understood that the terms so used are interchangeable under appropriate circumstances and that the embodiments of the present solution described herein are capable of operation in other sequences than described or illustrated herein.

Unless the context requires otherwise, where the term “comprising” or “including” or a variation thereof, such as “comprises” or “comprise” or “include”, is used in the present description and claims, it does not exclude other elements or steps and are to be construed in an open, inclusive sense, that is, as “including but not limited to”.

Where an indefinite or definite article is used when referring to a singular noun e.g. “a” or “an”, “the”, this includes a plural of that noun unless something else is specifically stated.

Appearances of the phrases “in some embodiments”, “in one embodiment” or “in an embodiment”, if any, in the description are not necessarily all referring to the same embodiment. Furthermore, the particular features, structures, or characteristics may be combined in any suitable manner in one or more embodiments.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

By the terms “configured” or “arranged” to perform a particular function, (and respective variations thereof) as they may be used herein, it is to be understood that a relevant device or component is already in a configuration or setting in which it can perform the function, or it is at least adjustable—i.e., configurable—in such a way that it can perform the function after appropriate adjustment. In this context, the configuration can be carried out, for example, by means of a corresponding setting of parameters of a process sequence or of hardware (HW) or software (SW) or combined HW/SW-switches or the like for activating or deactivating functionalities or settings. In particular, the device may have a plurality of predetermined configurations or operating modes so that the configuration can be performed by means of a selection of one of these configurations or operating modes.

Below, various aspects of the present solution will be discussed which pertain to different components and processes of an overall system for session key establishment, which act together to meet the above objective.

A first aspect of the present solution is directed to a method (“device-side method”) of establishing a cryptographic session key for protecting a communication between nodes in a communication network. The method is performed by a device, such as server device, acting as a first node, D, of the network and comprises:
(i) performing a mutual authentication with a trusted authentication service, AS, the authentication involving sending to AS authentication information for authenticating D, and receiving from AS authentication information for authenticating AS; and
(ii) creating a secure cryptographic session key using authentication parameters, AP, resulting from the authentication and a cryptographic key associated with D and known to AS, e.g., by being pre-shared; and
(iii) using the session key to protect subsequent actual data communication between D and one or more second nodes, C, of the network.

Accordingly, the device-side method serves to enable the device D to participate, acting as a first node of the network, in a protected communication with one or more second nodes C (“clients”) of the network.

In the following, without limitation, specific embodiments of the device-side method of the first aspect are described, which can be arbitrarily combined with each other or with other aspects of the present solution, unless such combination is explicitly excluded or technically impossible.

In some embodiments, performing the mutual authentication with AS comprises:
(i) using a challenge-response based mutual entity authentication protocol, the authentication involving an exchange between D and AS of information enabling each of AS and D to construct the authentication parameters based thereon. The authentication parameters represent: a unique identifier of D and a unique identifier of AS, a use case identifier of a use case for which the session key is to be established, first random information generated by D and communicated to AS, and second random information received by D from AS. The random information is included in the information exchanged between D and AS to enable the construction of the authentication parameters. D has a unique symmetric secret device key and this key or a reference to this key when stored externally, and the respective unique identifiers of D and AS are known to each of D and AS; and
(ii) storing the authentication parameters including a result of the authentication, the result indicating whether the authentication was successful.

In this way, a construction of the authentication parameters is enabled, both at D and at AS. Hereby, the random information involved increases an achievable security level associated with the subsequent communication between D and C to be protected by the established session key.

In some embodiments, the method comprises:
(i) receiving via the network from a second node, C, of the network a request for establishing a secure cryptographic session key being specific to the use case identified by the use case identifier, the request comprising supporting information including the identifier of D and an identifier of C, the use case identifier, and a first cryptographic signature obtainable by applying a defined pseudo-random function keyed with the secret device key and using the authentication parameters and the identifier of C as inputs;
(ii) verifying the request based on the supporting information and the device key of D, the verification including checking a validity of the first signature and comparing the authentication parameters retrieved from the supporting information with the authentication parameters previously stored; and
(iii) proceeding with creating the secure cryptographic session key only when the verification confirms both the validity of the first signature and the identity of the retrieved application parameters with the previously stored application parameters.

Accordingly, the establishment of a use-case-specific session key can be initiated by the (or more generally, any) second node (client) C and the use of the first signature and the associated verification and the result-dependent further proceeding can help increase the available security level of the solution.

In some embodiments, creating the secure cryptographic session key comprises:
(i) deriving a use-case-specific key of C using the device key of D, the stored authentication parameters, and the identifier of C received in the supporting information; and
(ii) deriving from the obtained use-case-specific key of C and the stored authentication parameters the session key specifically for the use case identified by the use case identifier.

This provides a secure way of enabling D to derive the use-case-specific session key based on the request received from C, thus avoiding a need to exchange the session key itself between D and C (or AS).

In some embodiments, the request further comprises a counter, Cnt, with Cnt=N+1, wherein N indicates a total number N of authentications performed in the past. The authentication parameters are defined so as to include a representation of Cnt and D uses Cnt for creating the secure cryptographic session key. Accordingly, keeping one or more previous versions of the authentication parameters enables a creation of session keys even if C (i.e. one or more clients) have not yet obtained the authentication parameters of the most recent authentication. A general policy can be used to define how many generations of authentication parameters are to be kept, and/or how long clients are allowed to use authentication parameters from a past authentication.

A second aspect of the present solution is directed to a method of establishing a cryptographic session key for protecting a communication between nodes in a communication network, the method being performed by a device acting as a second node, C, of the network (“client-side method”).

The client-side method comprises:
(i) registering C with a trusted authentication service, AS, for a specific use case, the registration involving receiving a cryptographic client key, K_{CDU}, from AS, the client key being specifically, e.g. uniquely, associated with C and with the use case;
(ii) receiving authentication parameters related to a mutual authentication of a first node D of the network to AS;
(iii) creating a secure cryptographic session key, K_{SU}, independently of D, using the authentication parameters and the cryptographic client key; and
(iii) using the session key to protect subsequent actual data communication between C and D.

Accordingly, the client-side method takes the role of a counterpart to the device-side method of the first aspect to enable with the involvement of AS the secure establishment of the use-case-specific symmetric session key at C for a protected communication between D and C without any need to exchange the session key itself between D and C.

In the following, without limitation, specific embodiments of the client-side method of the second aspect are described, which can be arbitrarily combined with each other or with other aspects of the present solution, unless such combination is explicitly excluded or technically impossible.

In some embodiments, the client-side method further comprises (particularly in a unicast scenario):
(i) Receiving a token from AS, the token comprising:
   the set of authentication parameters, AP, related to the mutual authentication of D with AS,
   a first cryptographic signature, S_{APD}, signing with a unique symmetric secret device key, K_{D}, associated with D, information representing both AP and an identifier of C, ID_{C}, and
   a second cryptographic signature, S_{APC}, signing with K_{CDU} information comprising both AP and ID_{C};
   verifying the validity of S_{APC} using K_{CDU} and ID_{C}; and
   when S_{APC} is found to be valid and the authentication result, Rslt, contained in the received AP is True, deriving the session key K_{SU} using K_{CDU} and the authentication parameters AP contained in T_{CDU} as follows: K_{SU}=HMAC_{KCDU} (ID_{C}∥ID_{D}∥L) with label L=U∥ID_{G}∥ID_{AS}∥Cnt∥R_{D}∥R_{AS}∥Rslt, where Rslt is True or False and indicates the result of the mutual authentication between D and AS.

The token thus allows for AS providing, in a secured manner, information to C which information is needed to enable C to construct the session key independently of D.

In some embodiments, registering C with AS for a specific use case further comprises receiving from AS a one-to-many use-case-specific group key, K_{GDU}, for enabling a subsequent creation of a group session key at multiple second nodes C belonging to a group for protected one-to-many communication between D and the one or more second nodes C in the group, the group key being specifically, e.g. uniquely, associated with the use case.

In this case, instead or in addition to the use-case-specific client key K_{CDU}, the use-case-specific group key K_{GDU} is provided by AS to C so as to enable C to construct the use-case-specific group session key independently of D for one-to-many communication involving D and multiple second node Cs.

Specifically, the method may further comprise:
(i) receiving a token, E_{AP}, from AS, the token being encrypted, keyed with K_{CDU}, and representing:
   identifiers of each of C, D, G, AS, and the use case;
   first random information generated by D and communicated to AS; and second random information communicated by AS to D, the random information being included in the information exchanged between D and AS to enable the construction of the authentication parameters during their mutual authentication; and
   a result of the mutual authentication; and
(ii) using the received token to derive based thereon the group session key.

The token thus allows for AS providing, in a secured manner, information to C which information is needed to enable C to construct the group session key independently of D.

A third aspect of the present solution is directed to a method (“AS-side method”) of operating a trusted authentication service, AS, for providing device authentication to support establishment of a cryptographic session key for protecting a communication between devices acting as nodes in a communication network. The method comprises:
(i) performing a mutual authentication with a device, D, the authentication involving receiving from D authentication information for authenticating D to AS, and sending authentication information for authenticating AS to D;
(ii) registering one or more second nodes, C, of the network and communicating to each of them a respective use-case-specific and client-specific client key, K_{CDU};
(iii) sharing one or more authentication parameters used in the authentication with each one of those second nodes, C, which are, as a result of a successful registration with AS, allowed to communicate with D.

Accordingly, the AS-side method completes an overall method for securely establishing session keys for protecting communication between a first node (device) D and one or more second nodes (C).

In the following, without limitation, specific embodiments of the AS-side method of the third aspect are described, which can be arbitrarily combined with each other or with other aspects of the present solution, unless such combination is explicitly excluded or technically impossible.

In some embodiments, further comprising communicating to a group defined as all or a subset of the successfully registered second nodes C a respective one-to-many use-case-specific group key for enabling a subsequent creation of a group session key for communication between D and the respective second node C of the group.

In some embodiments, the AS-side method further comprises: generating and communicating a token, E_{AP}, to C, the token being encrypted, keyed with the client key of C, K_{CDU}, and representing:
identifiers of each of C, D, G, AS, and the use case;
first random information generated by D and communicated to AS and second random information communicated by AS to D, the random information being included in the information exchanged between D and AS to enable the construction of the authentication parameters during their mutual authentication; and
a result of the mutual authentication.

This corresponds to the discussion provided above in relation to using such token at the client-side C to construct based thereon the group session key independently of D.

In some embodiments, the AS-side method further comprises selectively disabling the establishment of the session key for a communication between a particular device D and one or more particular clients C, by selectively omitting to generate or share authentication information needed for a successful establishment of the session key by either that particular D or each of the particular clients C, or by both.

Accordingly, the present solution allows for using AS to selectively enable or disable protected communication between a device-side and a client-side of the network.

A fourth aspect of the present solution is directed to a method (“overall method”) of establishing a cryptographic session key for protecting a communication between nodes in a communication network. The overall method comprises:
(i) performing the method of the first aspect by a device, acting as a first node, D, of the network;
(ii) performing the method of the second aspect by each of one or more client devices acting as a second node, C, of the network;
(iii) performing the method of the third aspect by an authentication system connected to the network and acting as an authentication service, AS;
wherein D, C and AS interact to create a session key for protecting a use-case-specific communication between D and C over the network.

A fifth aspect of the present solution is directed to a device, D, being configured to perform the method of the first aspect, thereby acting as the first node of the network.

A sixth aspect of the present solution is directed to a client device, C, being configured to perform the method of the second aspect, thereby acting as a second node of the network.

A seventh aspect of the present solution is directed to an authentication system being configured to perform the method of the method of the third aspect, thereby acting as the authentication service, AS, when connected to the network.

A eighth aspect of the present solution is directed to a system for establishing a cryptographic session key for protecting a communication between nodes in a communication network, the system comprising: a device, D, of the fifth aspect; one or more devices, C, of the sixth aspect; and an authentication system of the seventh aspect acting as the authentication service, AS, in the network. D, C and AS are collectively designed to interact in their respective roles according to the method of the fourth aspect to create a symmetric session key for protecting a use-case-specific communication between D and C over the network.

In summary, the present relates to authenticated secure session key establishment that can be used for protecting one-to-one and one-to-many communication scenarios between nodes, such as end points, in a communication network. The presented solution disseminates a mutual trust relation established between a trusted Authentication Service and one node D (responding device) to one or many other nodes C (clients) for creating actual session keys. This eliminates the need of performing typically resource-demanding mutual authentication between the responding device and all other clients C multiple times.

Actual session key creation uses symmetric cryptography only that makes it very fast and efficient. It also scales well with increasing number of clients due to dissemination of trust and is not resource demanding in particular for client nodes. Finally, this invention requires availability of a pseudorandom function (e.g. a keyed-hash function) and symmetric encryption function only for creating session keys.

Specifically, the presented solution can be used to improve deficits of Kerberos as follows: Authenticity of D is verified by AS explicitly and periodically. How often authenticity checks need to be performed is a parameter that can be configured. Session keys established between C and D need to be updated whenever a mutual authentication between AS and D is performed. AS has the possibility to block an unauthenticated D from communicating with C by informing C, e.g. by providing a specific authenticator parameter to C indicating D's invalid authenticity. No secure time synchronization is mandatory. The presented solution supports group key establishment for a multicast communication scenario.

### BRIEF DESCRIPTION OF THE DRAWINGS

Further advantages, features and applications of the present solution are provided in the following detailed description and the appended figures, wherein:

FIG. 1 shows a high-level outline of a system and overall method for session key establishment involving one or more client-nodes C;

FIG. 2 illustrates a scenario for a one-to-one (unicast) communication;

FIG. 3 illustrates a scenario for one-to-many (multicast) group communication;

FIG. 4; illustrates a scenario for many-to-one communication;

FIG. 5 is a chart illustrating an exemplary embodiment of a first variant (“Variant 1” or “V1”) of a method of for authenticated session key establishment in a one-to-one (unicast) scenario; and

FIG. 6 is a chart illustrating an exemplary embodiment of a second variant (“Variant 2” or “V2”) of a method of for authenticated session key establishment in a one-to-many (multicast) scenario.

In the figures, identical reference signs are used for the same or mutually corresponding elements of the systems and method described herein.

When the following refers to a “step” or “steps” of the method, this does not mean that the associated action must necessarily take place in a single coherent operation. Rather, it is also possible that a “step” is composed of several individual operations in the sense of a process and thus corresponds to a sub-process of the method.

In order to provide better orientation to the reader, several headlines have been provided herein to structure the below overview of the various aspects of the overall solution. However, these headlines are in no way intended to limit the invention disclosed herein. In particular, any definitions of terms provided herein are applicable throughout this document and are not limited to an application to a particular section, aspect or embodiment contained herein.

### DETAILED DESCRIPTION

FIG. 1 shows a high-level outline of a system and overall method 100 for session key establishment between one responding device D acting as a first node of a communication network NW and one or multiple client devices (clients), C, acting as second nodes of the network NW. The method further involves use of an online trusted Authentication Service AS. Accordingly, the system comprises the responding device D, the one or more client devices C and the Authentication Service AS.

Method 100 is referred to as an “overall” method because it defines, on a high level, an interplay of several individual methods to be performed individually by D, C and AS respectively, but which collectively serve to establish the desired session key(s). Accordingly, each of the individual methods provides interacts with the other individual methods to that purpose and provides an individual contribution thereto, as explained in more detail below.

The (overall) method 100 comprises the following steps 1 to 5:

Step 1: A challenge-response based mutual entity authentication using random numbers is performed between D and AS (instead of D and C) in order to address scalability problems of known methods. The number of individual mutual authentication executions required depends on the number of use cases U for which session keys need to be created.

Step 2: the dashed double-arrow relating to Step 2 in FIG. 1 indicates a registration process, in which the one or multiple clients C each register with AS and in response are provided with use-case and client-specific client keys being transmitted to the client(s) C.

Step 3: In order to overcome efficiency (in particular computational) problems of known methods, authentication parameters AP of a successful mutual authentication to be used for creating session keys are provided to all those clients C (via push or pull) which are registered for a given use case U at AS. In order to prevent clients from communicating with an unauthentic responding device D, authentication parameters AP of an unsuccessful mutual authentication are provided to corresponding clients C to inform them about the inauthenticity of D. The AP comprises a use case identifier U, both random numbers generated by D and AS during mutual authentication and a parameter indicating an authentication result, and optionally: an identifier of D, an identifier of AS, a group identifier, and a mutual authentication sequence number. Additionally, a cryptographic checksum to be verified by C and another cryptographic checksum to be verified by D may be provided to C together with AP.

Step 4: In order to address efficiency (in particular computational) problems of known methods, every client C computes its session key for U using a pseudo-random function (PRF). In this computation, AP obtained from AS and a use-case-specific client key which was also obtained from AS during the registration process of Step 2 are used. D computes the same session key using AP negotiated with AS and a device-specific key.

Step 5: The session key itself or sub-session keys derived from it can be used to protect the actual data communication between D and C. The dashed arrows relating to Step 5) in FIG. 1 indicate a security protocol for protecting actual data to be communicated between D and C.

Computation of session keys or (or sub-session keys) is very fast as it uses a PRF and symmetric key encryption. In order to address the dependency of known methods on the availability of a good pseudo random number generator at clients, session key creation is based on a pseudo-random function (PRF) and symmetric key encryption only.

The session key (or sub-session keys) established between D and C need to be updated (re-computed) whenever a mutual authentication between D and AS is performed. Both D and AS can (individually or collectively) initiate a mutual authentication to be executed.

Method 100 is independent of any underlying transport protocol or connectivity technology (e.g., LAN, WLAN, Internet, LTE, 5G, etc.) used in the network. The trusted AS needs to be online and available for performing the process of mutual entity authentication with D and providing AP to C. The frequency of this process is a parameter that can be configured and generally assumed to be low (e.g. every 24 hours) for many use cases.

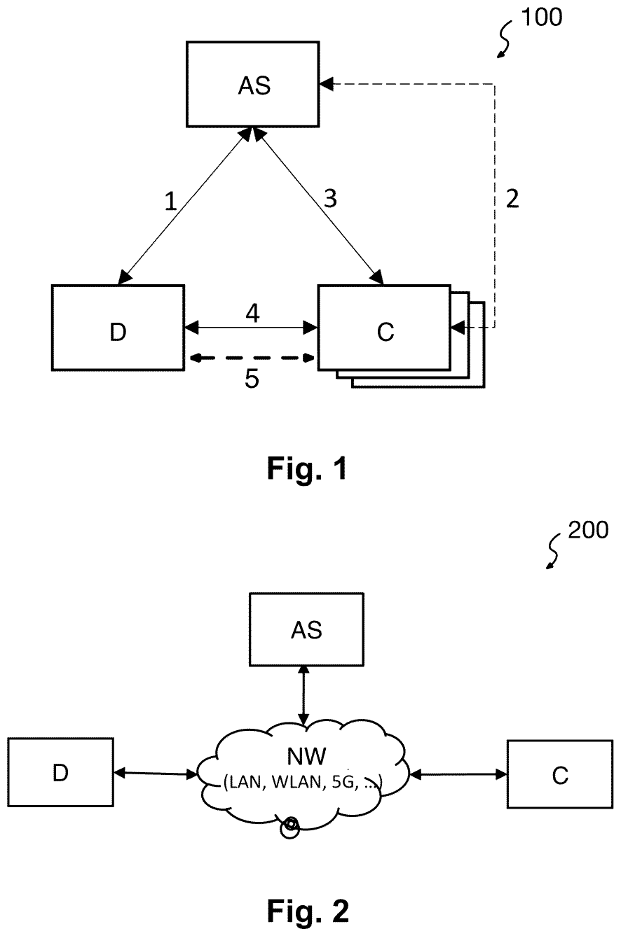

Method 100 is particularly useful for key establishment in the communication scenarios illustrated in FIGS. 2, 3 and 4.

### Scenarios

FIG. 2 illustrates a key establishment scenario for a one-to-one (unicast) communication over the network NW. D, C and AS can be in the same trust boundary (e.g. trust boundary of a company network) or outside each other's trust boundaries requiring a communication partly or fully through a public network.

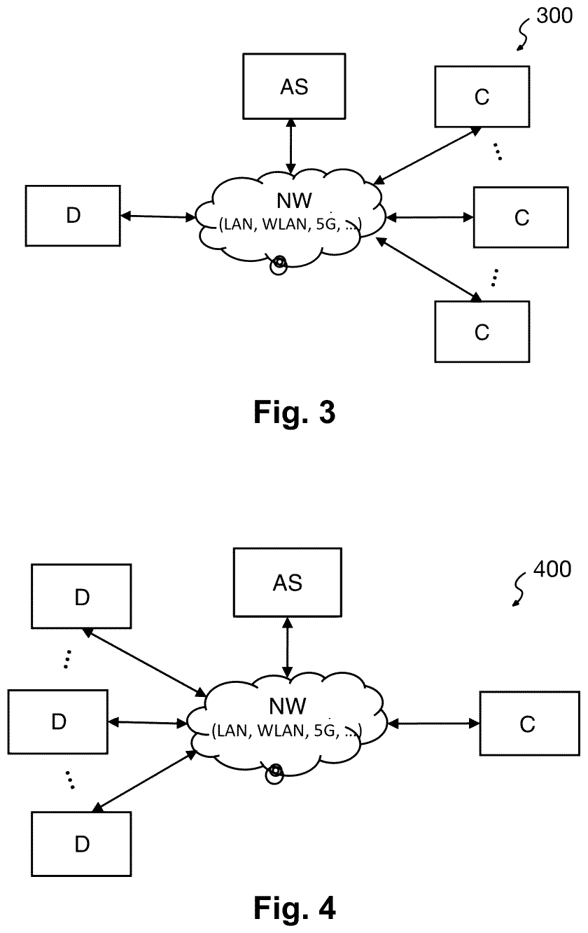

FIG. 3 illustrates a key establishment scenario for one-to-many (multicast) group communication over the network NW. Similar to the unicast scenario of FIG. 2, D, C and AS can communicate partly or fully through a public network.

FIG. 4 illustrates a many-to-one key establishment scenario in which a client C communicates with a plurality of nodes D over the network NW. This scenario is implemented by key establishments executed between the different nodes D on the one hand and a same C on the other hand.

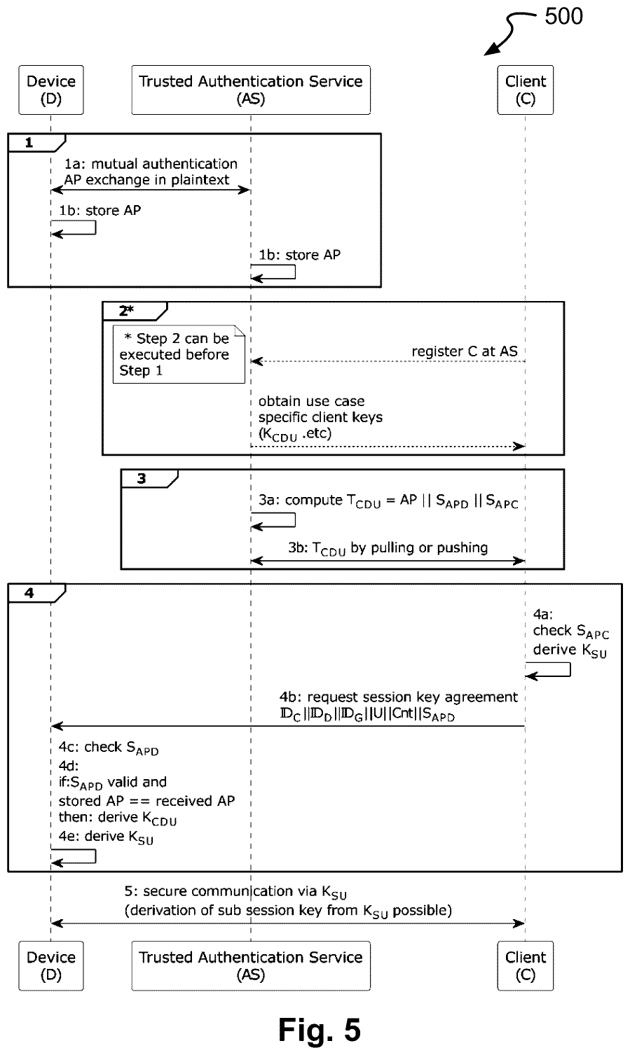

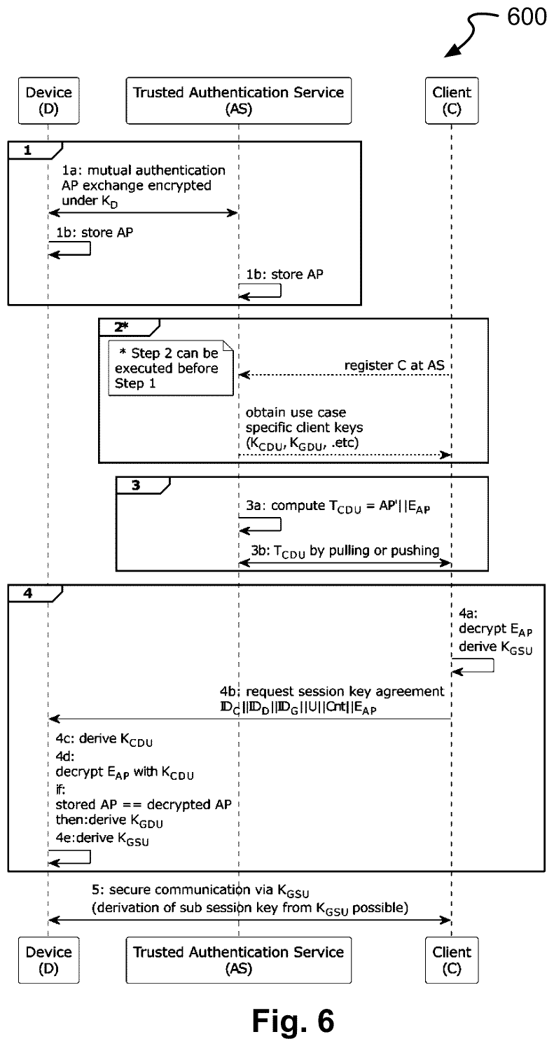

Referring now again to FIG. 1 in combination with FIGS. 5 and 6, overall method 100 can be implemented in at least the following three variants: first Variant (Variant 1, V1, One-to-One key establishment), a second variant (Variant 2, V2, One-to-Many (multicast) group key establishment), and a third variant (Variant 3, V3, Many-to-One key establishment).

The first Variant V1, an exemplary embodiment of which is exemplarily illustrated in FIG. 5, can be used for a secure session key establishment between one D and one C (one-to-one communication scenario, cf. FIG. 2).

The second Variant V2, an exemplary embodiment of which is exemplarily illustrated in FIG. 6, can be used for a secure group session key establishment between one D and many C (one-to-many multicast group communication scenario, cf. FIG. 3).

The third Variant V3 is based on multiple applications of Variant 1, executed between different devices D and a same C.

### Assumptions

Before these embodiments will be discussed in more detail below, for the sake of a better explanation, certain assumptions need to be explicitly made as a starting point, which can be applied independent of the chosen Variant/embodiment, i.e. of the relevant key establishment scenario.

Each responding device D is in possession of a unique symmetric secret key K_{D} and a unique identifier ID_{D} which are both known to AS. AS stores the respective identifier ID_{D} of each device D, its key K_{D} (or a reference to the actual key if it is stored e.g. in an external secure storage (like a Hardware Security Module HSM) with some other information in a secure database. Additionally, each device D is assumed to store a digital certificate, corresponding private key and certificate chain required for verifying AS certificate in case a mutual authentication with certificates is used in Step 1 of FIG. 5 and FIG. 6, respectively.

Similarly, AS is also assumed to have a certificate, required for verifying device certificates in this case. Each client device C is (or will be in the course of the method) in possession of at least one use-case-specific symmetric client key (K_{CDU}) for each D with which C is supposed to establish a secure communication. In the unicast scenario, C uses this key to create a session key (K_{SU}) for protecting actual one-to-one data communication with D. In the multicast scenario, a separate use-case-specific client key (K_{GDU}) needs to be provided to C to be used for creating a group session key (K_{CDU}) for protecting multicast group communication.

Clients C are allowed to have an unlimited number of use-case-specific client keys. Each use-case-specific client key is derived from a corresponding device key K_{D}, use case identifier U, client identifier (ID_{C}), device D identifier ID_{D}, group identifier ID_{G} with some other parameters using a PRF similar to that in [2].

ID_{G} can be set to a constant value (e.g. 0x00) to indicate that the key being derived is a K_{CDU} to be used for one-to-one unicast communication. Clients C store their use-case-specific client keys K_{CDU}, K_{GDU} in a protected storage.

Use-case-specific client keys K_{CDU}, K_{GDU} can be transmitted to C in many ways, e.g. by means of QR code or manually. This can be done during a registration of C at AS for a use case U at D. It is required that the use-case-specific keys are known to C for use in Step 3 of FIG. 5 and FIG. 6, respectively.

### First Variant (Variant 1)—One-to-One Key Establishment

The first variant is directed to the objective of creating a session key K_{SU} between one device D and one client C so that K_{SU} can be used for protecting actual one-to-one data communication between C and D in use case U.

FIG. 5 illustrates an embodiment of the first Variant in the form of a method 500 for establishing session key K_{SU} between D and C.

Herein, the notation “Vx.yz” is used in relation to FIG. 5 (and FIG. 6) to denote method steps. Herein, “V” stands for “Variant” and “x” for the chosen variant, e.g. V1 for the first variant. “y” denotes a particular step and “z” a particular sub-step thereof, within the method in question. By way of example, the notation “V1.1a” indicates sub-step “a” in step 1 of the first variant. In order to limit complexity, in the following, sub-steps are also referred to as “steps” instead of “sub-steps”.

Step V1.1a: A challenge-response based mutual entity authentication protocol between D and AS is executed. In V1, random challenges R_{D} and R_{AS} are exchanged in plaintext.

ISO/IEC 9798 [8] specifies several mutual entity authentication protocols. The three-pass mutual entity authentication based on digital signatures using random challenges and certificates can be used in Sub-step 1a. Use of other protocols based on different cryptographic algorithms like symmetric enciphering algorithms or cryptographic check functions is also allowed. The primary requirement on a selected protocol is that it must ensure mutual authentication and use random numbers as time-variant parameter(s).

Execution of mutual entity authentication can be initiated by D or AS, or both.

A request message initiating a mutual authentication contains U, ID_{G} and a counter (Cnt) indicating a total number of authentications performed in the past plus one (+1), and other parameters required by the mutual authentication protocol. ID_{G} does not need to be included in the request message, if it is set to a constant value (e.g., 0x00) and can be implied from U.

How often the mutual entity authentication needs to be performed is a parameter that can be configured for both D and AS.

Step V1.1b: AS and D each store authentication parameters AP obtained from the Cnt′th mutual authentication, wherein AP are created as follows:
if the authentication is successful:

AP=U∥ID_{D}∥ID_{AS}∥ID_{G}∥Cnt∥R_{D}∥R_{AS}∥True
if the authentication is unsuccessful:

AP=U∥ID_{D}∥ID_{AS}∥ID_{G}∥Cnt∥R_{D}∥R_{AS}∥False

“True” or “False” in AP of one entity indicates the authenticity status of another entity. That means, “True” in the AP stored by AS means that AS verified D's identity successfully. Similarly, “True” in the AP stored by D means that D verified AS's identity successfully. “False” in an AP indicates that the authenticity of the corresponding entity could not be verified. This ensures that C and D compute the same session key (in steps V1.4a and V1.4e) only if D and AS verify each other's identity successfully (mutual authentication).

AS and D also keep the AP of the (Cnt−1)′th authentication. Keeping a previous AP is necessary to be able to create session keys even if (some) clients have not yet obtained the AP of the most recent Cnt′th authentication. A general policy can be used to define how many APs to be kept, how long clients are allowed to use an AP from a past authentication.

Step V1.2: C is assumed to be given a use-case-specific client key K_{CDU} created by AS to be used in creating session keys for use case U with device D. This is done e.g. during registration of C at AS for U with D. C is assumed to store those client-specific keys together with parameters U, ID_{G}, ID_{D} and ID_{AS} to identify use cases in which they are supposed to be used. K_{CDU} is derived from K_{D}, U, ID_{C}, ID_{D}, ID_{AS}, ID_{G} using a pseudo-random function PRF as follows:

$${K}_{CDU} = {HMAC}_{KD} ( {ID}_{C} ‖ {ID}_{D} ‖ L ) \qquad ( 1 )$$

with label L=U∥ID_{G}∥ID_{AS}.

Any other practical implementation of PRF can be used instead of HMAC [9] for key derivations in the solution. A key derivation function as specified in [2] can also be used.

K_{CDU} can be transmitted to C in many ways, e.g. by means of a QR code or manually. This can be done during registration of C at AS for a use case U with D.

Step V1.3a: AS computes a token T_{CDU} for every registered client C for use case U with D as follows:

$${T}_{CDU} = AP ‖ {S}_{APD} ‖ {S}_{APC} \qquad ( 2 )$$

with S_{APD}=HMAC_{KD}(AP∥ID_{C}) and S_{APC}=HMAC_{KCDU} (AP∥ID_{C}).

HMAC or another MAC algorithm can be used for computing symmetric signatures S_{APD} and S_{APC}.

Step V1.3b: T_{CDU} is shared with C (e.g. it can be pushed to C or pulled by C). The requirement is that C needs to receive a new token every time when a mutual authentication between D and AS is executed (i.e. whenever AP changes).

Step V1.4a: C first verifies that S_{APC} received in is valid by using its own use-case-specific client key K_{CDU} and identity ID_{C}. If S_{APC} is valid and the authentication result contained in the received AP is True, then C derives the session key K_{SU} using K_{CDU} and authentication parameters contained in T_{CDU} as follows:

$${K}_{SU} = {HMAC}_{KCDU} ( {ID}_{C} ‖ {ID}_{D} ‖ L ) \qquad ( 3 )$$

with label L=U∥ID_{G}∥ID_{AS}∥Cnt∥R_{D}∥R_{AS}∥Rslt, where Rslt is True or False and indicates the result of mutual authentication from Step V1.1a.

Step V1.4b: C sends a session key establishment request to D to indicate that C wants to establish a session key K_{SU} with D for protecting communication with D in use case U. The request message is composed of ID_{C}, ID_{D}, ID_{G}, U, Cnt and S_{APD} received in Step V1.3b.

Step V1.4c: D verifies S_{APD} using its own device key K_{D}, parameters stored in its copy of AP (identified by U and ID_{G} and Cnt) and ID_{C} received in the request message.

Step V1.4d: If S_{APD} is valid, the request is addressed to D and parameters received in the request match with them locally stored in AP (identified by U, ID_{G} and Cnt), then D derives client's use-case-specific key K_{CDU}. For this, D uses its own device key K_{D} and parameters from locally stored AP and ID_{C} received in the request message as follows:

$${K}_{CDU} = {HMAC}_{KD} ( {ID}_{C} ‖ {ID}_{D} ‖ L ) \qquad ( 4 )$$

with label L=U∥ID_{G}∥ID_{AS}. Otherwise (if any check above is false), D returns an appropriate error message to C indicating that the problem occurred. Specifically, the error message may also indicate which one or more problems occurred.

Step V1.4e: Finally, D derives the session key K_{SU} using AP stored in Step V1.1b, K_{CDU} derived in Step V1.4d and ID_{C} received in request message in step V1.4b as follows:

$${K}_{SU} = {HMAC}_{KCDU} ( {ID}_{C} ‖ {ID}_{D} ‖ L ) \qquad ( 5 )$$

with label L=U∥ID_{G}∥ID_{AS}∥Cnt∥R_{D}∥R_{AS}∥Rslt, where Rslt is True or False and indicating the result of mutual authentication from Step V1.1a.

Step V1.5: D and C can communicate with each other securely if they both computed the same session key K_{SU} in step 4e. K_{SU} (or sub-session keys derived from it) can be used to protect actual data communication between D and C.

### Second Variant (Variant 2)—One-to-Many Key Establishment

The second variant is directed to the objective of creating a group session key K_{CDU} between one D and many C that can be used for protecting actual one-to-many multicast data communication in use case U with D.

FIG. 6 illustrates an embodiment of the second Variant V2 in the form of a method 600 for establishing a group session key K_{GSU}.

Step V2.1a: Execution of multicast entity authentication for (multicast) group key establishment is analog to that described in Step V1.1a for one-to-one key establishment with the following difference: Random challenges R_{D} and R_{AS} need to be encrypted under D's device key K_{D} which is known to both D and AS. Use of other mutual authentication protocols based on cryptographic algorithms ensuring confidentiality of random challenges exchanged is also allowed.

Step V2.1b: AS and D store authentication parameters AP obtained from the Cnt′th mutual authentication. Execution of this is analog to that described above in Step V1.1b for one-to-one key establishment, including requirements and notes on the storage of APs from past authentications.

Step V2.2: C is assumed to be given use-case-specific client keys K_{CDU} and K_{GDU} both created by AS. This is done e.g. during registration of C at AS for multicast communication use case with D. C is assumed to store those client-specific keys together with parameters U, ID_{G}, ID_{D} and ID_{AS} to identify use cases in which they are supposed to be used.

Derivation of K_{CDU} is analog to that described in Step V1.2 for one-to-one key establishment. That is, K_{CDU} is derived from K_{D}, U, ID_{C}, ID_{D}, ID_{AS}, ID_{G} using a pseudo-random function PRF as according to equation (1) provided above as follows:

K_{CDU}=HMAC_{KD}(ID_{C}∥ID_{D}∥L) with label L=U∥ID_{G}∥ID_{AS}.

Any other practical implementation of PRF can be used instead of HMAC [9] for key derivations in the solution. A key derivation function as specified in [2] can also be used.

Derivation of K_{GDU} is analog to derivation of K_{CDU}. It differs from K_{CDU} only in terms of values assigned to U and ID_{G}. ID_{C} is not included in the derivation of K_{GDU}.

That is, K_{GDU} is derived from K_{D}, U, ID_{D}. ID_{G}, ID_{AS} using a pseudo-random function PRF as follows:

$${K}_{GDU} = {HMAC}_{KD} ( {ID}_{D} ‖ L ) \qquad ( 6 )$$

with label L=U∥ID_{G}∥ID_{AS}.

Any other practical implementation of PRF can be used instead of HMAC [9] for key derivations in the solution. A key derivation function as specified in [2] can also be used.

K_{CDU} and K_{GDU} can be transmitted to C in many ways, e.g. by means of a QR code or manually. This can be done during registration of C at AS for a use case U with D.

Step V2.3a: AS computes a token T_{CDU} for every registered client C for use case U with D as a part of a group ID_{G} as follows:

$${T}_{CDU} = {AP}^{′} ‖ {E}_{AP} \qquad ( 7 )$$

with

AP′=ID_{C}∥ID_{D}∥ID_{G}∥U∥Cnt and

E_{AP}=ENC_{KCDU}(AP′∥ID_{AS}∥R_{D}∥R_{AS}∥Rslt).

AES-256 or another secure symmetric encryption algorithm can be used for encryption.

Step V2.3b: T_{CDU} is shared with C (e.g. it can be pushed to C or pulled by C). The requirement is that C needs to receive a new token every time when a mutual authentication between D and AS is executed (i.e. whenever AP changes) and when members of a group change which it belongs to.

Step V2.4a: C derives the session key K_{CDU} using its use-case-specific client keys K_{CDU}, K_{GDU} and authentication parameters received in T_{CDU} as follows: C firstly decrypts E_{AP} received in T_{CDU} using K_{CDU} to obtain AP′, R_{D}, R_{AS} and Rslt required for computing K_{CDU}. C checks if Rslt obtained from E_{AP} is True, ID_{C} obtained from E_{AP} matches with its own ID and ID_{D} matches with ID of the device (ID_{D}) to be communicated and ID_{D} received in T_{CDU}. Finally, if all checks above are valid, C derives the group session key K_{CDU} using K_{GDU} as follows:

$${K}_{GSU} = {HMAC}_{KGDU} ( {ID}_{D} ‖ L ) \qquad ( 8 )$$

with label L=U∥ID_{G}∥ID_{AS}∥Cnt∥R_{D}∥R_{AS}∥Rslt.

Step V2.4b: C sends a session key establishment request to D to indicate that C wants to establish a group session key K_{CDU} for protecting communication with D in a use case U as a part of group ID_{G}. The request message is composed of ID_{C}, ID_{D}, ID_{G}, U, Cnt and E_{AP} which is received in Step V2.3b.

Step V2.4c: D derives K_{CDU} using its own local copy of AP (identified by U and ID_{G} and Cnt) and its own device key K_{D} and ID_{C} received in the request as follows:

$${K}_{CDU} = {HMAC}_{KD} ( {ID}_{C} ‖ {ID}_{D} ‖ L ) \qquad ( 9 )$$

with label L=U∥ID_{G}∥ID_{AS}.

Step V2.4d: D firstly decrypts E_{AP} received in the request message using K_{CDU} which is derived in Step V2.4c. D checks if the parameters in AP′ and Cnt, R_{D}, R_{AS} Rslt obtained from the decrypted E_{AP} match with them in locally stored AP (identified by U, ID_{G} and Cnt). Finally, if all checks above are valid, D derives the use-case-specific client group key K_{GDU} using device key K_{D} as follows:

$${K}_{GDU} = {HMAC}_{KD} ( {ID}_{D} ‖ L ) \qquad ( 10 )$$

with label L=U∥ID_{G}∥ID_{AS}.

Otherwise (if any check above is false), D returns an appropriate error message to C Indicating that the problem occurred. Specifically, the error message may also indicate which one or more problems occurred.

Step V2.4e: Finally, D derives the group session key K_{CDU} using AP stored in step V2.1b, 740 K_{GDU} derived in Step V2.4d and ID_{C} received in request message in step V2.4b as follows:

$${K}_{GSU} = {HMAC}_{KGDU} ( {ID}_{D} ‖ L ) \qquad ( 11 )$$

with label L=U∥ID_{G}∥ID_{AS}∥Cnt∥R_{D}∥R_{AS}∥Rslt.

Step 5: D and C can communicate with each other securely if they both computed the same group session key K_{CDU} in steps V2.4a and V2.4e, respectively. K_{CDU} (or sub-session keys derived from it) can be used to protect actual multicast data communication between D and C.

### Third Variant-Many-to-One Key Establishment

This embodiment is implemented by many one-to-one key establishments (per first embodiment/Variant 1) executed between different devices D and the same C.

While above at least one exemplary embodiment of the present solution has been described, it has to be noted that a great number of variations thereto exists. Furthermore, it is appreciated that the described exemplary embodiments only illustrate non-limiting examples of how the present solution can be implemented and that it is not intended to limit the scope, the application or the configuration of the herein-described apparatuses and methods. Rather, the preceding description will provide the person skilled in the art with constructions for implementing at least one exemplary embodiment of the present solution, wherein it must be understood that various changes of functionality and the arrangement of the elements of the exemplary embodiment can be made, without deviating from the subject-matter defined by the appended claims.

### LIST OF REFERENCE SIGNS AND NOTATION

D Entity serving as a responding device
C Entity serving as an initiating client device (client)
AS Entity serving as a trusted authentication service
AP Authentication parameters
K_{D} Device-specific secret key
ID_{D} Unique device ID
ID_{C} Unique client ID
ID_{AS} Unique AS ID
ID_{G} (Multicast) Group ID
U Use Case ID
K_{CDU} C's use-case-specific key for D
K_{GDU} C's group-specific key for D
T_{CDU} C's use-case-specific token for D
S_{APD} AP signed for D
S_{APC} AP signed for C
E_{AP} AP encrypted for C
K_{SU} One-to-One session key for use case U
K_{GSU} One-to-Many group session key for use case U
R_{D} Random challenge generated by D
R_{AS} Random challenge generated by AS
PRF Pseudo-random Function
HSM Hardware Security Module
Encₖ(·) Encryption under secret key K
(x∥y): Concatenation of x and y
Cn Counter indicating the total number of authentications performed between D and AS for U
NW network
1, . . . , 5 method steps, overall
Vx.yz sub-step z in step y of Variant x, in embodiments 500, 600
100 overall method
200 one-to-one scenario
300 one-to-many scenario
400 many-to-one scenario
500 embodiment of first Variant V1 (unicast)
600 embodiment of second Variant V2 (multicast)

### REFERENCES

[1] Dr. Clifford Neuman, Sam Hartman, Kenneth Raeburn, and Taylor Yu. The Kerberos Network Authentication Service (V5). RFC 4120 July 2005. URL https://www.rfc-editor.org/info/rfc4120.
[2] Karl Norrman, Fredrik Lindholm, Elisabetta Carrara, Jari Arkko, and Mats Naslund. MIKEY: Multimedia Internet KEYing. RFC 3830 August 2004. URL https://www.rfc-editor.org/info/rfc3830
[3] Martin Euchner. HMAC-Authenticated Diffie-Hellman for Multimedia Internet KEYing (MIKEY). RFC 4650 September 2006. URL https://www.rfc-editor.org/info/rfc4650.
[4] Lakshminath R. Dondeti, Ping Lin, Dragan Ignjatic, and Francois Audet. MIKEY-RSA-R: An Additional Mode of Key Distribution in Multimedia Internet KEYing (MIKEY). RFC 4738 November 2006. URL https://www.rfc-editor.org/info/rfc4738.
[5] Violeta Cakulev and Ganapathy Sundaram. MIKEY-IBAKE: Identity-Based Authenticated Key Exchange (IBAKE) Mode of Key Distribution in Multimedia Internet KEYing (MIKEY). RFC 6267 June 2011. URL https://www.rfc-editor.org/info/rfc6267.
[6] Michael Groves. MIKEY-SAKKE: Sakai-Kasahara Key Encryption in Multimedia Internet KEYing (MIKEY). RFC 659 February 2012. URL https://www.rfc-editor.org/info/rfc6509.
[7] John Preuß Mattsson and Tian Tian. MIKEY-786 TICKET: Ticket-Based Modes of Key Distribution in Multimedia Internet KEYing (MIKEY). RFC 643 March 2011. URL https://www.rfc-editor.org/info/rfc6043.
[8] International Organization for Standardization. Information technology-Security techniques-Entity authentication-Part 1: General. International Organization for Standardization, Geneva, Switzerland, ISO 9797-2:2021 edition, 2010. URL https://www.iso.org/standard/53634.html.
[9] Dr. Hugo Krawczyk, Mihir Bellare, and Ran Canetti. HMAC: Keyed-Hashing for Message Authentication. RFC 214 February 1997. URL https://www.rfc-editor.org/info/rfc2104.

1. A method of establishing a cryptographic session key for protecting a communication between nodes in a communication network (NW), the method being performed by a device acting as a first node, D, of the network (NW) and comprising:
performing a mutual authentication with a trusted authentication service, AS, the authentication involving sending to AS authentication information for authenticating D, and receiving from AS authentication information for authenticating AS;
and
creating a secure cryptographic session key using authentication parameters (AP; AP′) resulting from the authentication and a cryptographic key (K_{CDU}; K_{GDU}) associated with D and known to AS; and
using the session key (K_{SU}; K_{GSU}) to protect subsequent actual data communication between D and one or more second nodes, C, of the network (NW).

2. The method of claim 1, wherein performing the mutual authentication with AS comprises:
using a challenge-response based mutual entity authentication protocol, the authentication involving an exchange between D and AS of information enabling each of AS and D to construct the authentication parameters (AP) based thereon, the authentication parameters (AP) representing a unique identifier (ID_{D}) of D and a unique identifier (ID_{AS}) of AS, a use case identifier (U) of a use case for which the session key (K_{SU}; K_{GSU}) is to be established, first random information (R_{D}) generated by D and communicated to AS, and second random information (R_{AS}) received by D from AS, the random information being included in the information exchanged between D and AS to enable the construction of the authentication parameters, wherein D has a unique symmetric secret device key (K_{D}) and this key or a reference to this key when stored externally, and the respective unique identifiers (ID_{D}; ID_{AS}) of D and AS are known to each of D and AS; and
storing the authentication parameters (AP; AP′) including a result (Rslt) of the authentication, the result (Rslt) indicating whether the authentication was successful.

3. The method of claim 2, comprising:
receiving via the network from a second node, C, of the network a request for establishing a secure cryptographic session key (K_{SU}) being specific to the use case identified by the use case identifier, the request comprising supporting information including the identifier of D and an identifier of C, the use case identifier, and a first cryptographic signature (S_{APD}) obtainable by applying a defined pseudo-random function (PRF) keyed with the secret device key (K_{D}) and using the authentication parameters (AP) and the identifier (ID_{C}) of C as inputs;
verifying the request based on the supporting information and the device key (K_{D}) of D, the verification including checking a validity of the first signature (S_{APD}) and comparing the authentication parameters retrieved from the supporting information with the authentication parameters previously stored; and
proceeding with creating the session key (K_{SU}) only when the verification confirms both the validity of the first signature (S_{APD}) and the identity of the retrieved application parameters with the previously stored application parameters.

4. The method of claim 2, wherein creating the secure cryptographic session key comprises:
deriving a use-case-specific key (K_{CDU}) of C using the device key (K_{D}) of D, the stored authentication parameters, and the identifier (ID_{C}) of C received in the supporting information; and
deriving from the obtained use-case-specific key (K_{CDU}) of C and the stored authentication parameters the session key (K_{SU}) specifically for the use case identified by the use case identifier (U).

5. The method of claim 1, wherein:
the request further comprises a counter, Cnt with Cnt=N+1, wherein N indicates a total number N of authentications performed in the past;
the authentication parameters are defined so as to include a representation of Cnt; and
D uses Cnt for creating the session key.

6. A method of establishing a cryptographic session key for protecting a communication between nodes in a communication network, the method being performed by a device acting as a second node, C, of the network and comprising:
registering C with a trusted authentication service, AS, for a specific use case, the registration involving receiving a cryptographic client key, K_{CDU}, from AS, the client key being specifically associated with C and with the use case;
receiving authentication parameters, AP, related to a mutual authentication of a first node D of the network to AS;
creating a secure cryptographic session key, K_{SU}, independently of D, using AP and K_{CDU}; and
using K_{SU} to protect subsequent actual data communication between C and D.

7. The method of claim 6, further comprising:
receiving a token from AS, the token comprising:
the set of authentication parameters, AP, related to the mutual authentication of D with AS,
a first cryptographic signature, S_{APD}, signing with a unique symmetric secret device key, K_{D}, associated with D, information representing both AP and an identifier of C, ID_{C}, and
a second cryptographic signature, S_{APC}, signing with K_{CDU} information comprising both AP and ID_{C};
verifying the validity of S_{APC} using K_{CDU} and ID_{C}; and
when S_{APC} is found to be valid and the authentication result, Rslt, contained in the received AP is True, deriving the session key K_{SU} using K_{CDU} and the authentication parameters (AP) contained in T_{CDU} as follows: K_{SU}=HMAC_{KCDU} (ID_{C}∥ID_{D}∥L) with label L=U∥ID_{G}∥ID_{AS}∥Cnt∥R_{D}∥R_{AS}∥Rslt, where Rslt is True or False and indicates the result of the mutual authentication between D and AS.

8. The method of claim 6, wherein registering C with AS for a specific use case further comprises receiving from AS a one-to-many use-case-specific group key (K_{GDU}) for enabling a subsequent creation of a group session key at multiple second nodes C belonging to a group, G, for protected one-to-many communication between D and the one or more second nodes C in the group, the group key (K_{GDU}) being specifically associated with the use case.

9. The method of claim 8, the method further comprises:
receiving a token, E_{AP}, from AS, the token being encrypted, keyed with K_{CDU}, and representing:
identifiers of each of C, D, G, AS, and the use case;
first random information generated by D and communicated to AS; and
second random information communicated by AS to D, the random information being included in the information exchanged between D and AS to enable the construction of the authentication parameters during their mutual authentication; and
a result of the mutual authentication; and
using the received token to derive based thereon the group session key.

10. A method of operating a trusted authentication service, AS, for providing device authentication to support establishment of a cryptographic session key for protecting a communication between devices acting as nodes in a communication network, the method comprising:
performing a mutual authentication with a device, D, the authentication involving receiving from D authentication information for authenticating D to AS, and sending authentication information for authenticating AS to D;
registering one or more second nodes, C, of the network and communicating to each of them a respective use-case-specific and client-specific client key (K_{CDU});
sharing one or more authentication parameters AP used in the authentication with each one of those second nodes, C, which are, as a result of a successful registration with AS, allowed to communicate with D.

11. The method of claim 10, further comprising communicating to a group defined as all or a subset of the successfully registered second nodes C a respective one-to-many use-case-specific group key (K_{GDU}) for enabling a subsequent creation of a group session key for communication between D and the respective second node C of the group.

12. The method of claim 11, the method further comprising:
generating and communicating a token, E_{AP}, to C, the token being encrypted, keyed with the client key of C, K_{CDU}, and representing:
identifiers of each of C, D, G, AS, and the use case;
first random information generated by D and communicated to AS and second random information communicated by AS to D, the random information being included in the information exchanged between D and AS to enable the construction of the authentication parameters during their mutual authentication; and
a result of the mutual authentication.

13. The method of claim 10, comprising selectively disabling the establishment of the session key for a communication between a particular device D and one or more particular clients C, by selectively omitting to generate or share authentication information needed for a successful establishment of the session key by either that particular D or each of the particular clients C, or by both.

14. Method of establishing a cryptographic session key for protecting a communication between nodes in a communication network, the method comprising:
performing, by a device, acting as a first node, D, of the network, a method comprising the method of claim 1;
performing, by each of one or more client devices acting as a second node, C, of the network, registering C with a trusted authentication service, AS, for a specific use case, the registration involving receiving a cryptographic client key, K_{CDU}, from AS, the client key being specifically associated with C and with the use case; receiving authentication parameters, AP, related to a mutual authentication of a first node D of the network to AS; creating a secure cryptographic session key, K_{SU}, independently of D, using AP and K_{CDU}; and using K_{SU} to protect subsequent actual data communication between C and D;
performing, by an authentication system connected to the network and acting as an authentication service, AS, a method comprising performing a mutual authentication with a device, D, the authentication involving receiving from D authentication information for authenticating D to AS, and sending authentication information for authenticating AS to D; registering one or more second nodes, C, of the network and communicating to each of them a respective use-case-specific and client-specific client key (K_{CDU}); sharing one or more authentication parameters AP used in the authentication with each one of those second nodes, C, which are, as a result of a successful registration with AS, allowed to communicate with D;
wherein D, C and AS interact to create a session key for protecting a use-case-specific communication between D and C over the network.

15. Device, D, being configured to perform the method of claim 1, thereby acting as the first node of the network.

16. Client device, C, being configured to perform the method of claim 6, thereby acting as a second node of the network.

17. Authentication system being configured to perform the method of claim 10, thereby acting as the authentication service, AS, when connected to the network.

18. System for establishing a cryptographic session key for protecting a communication between nodes in a communication network, the system comprising:
a device, D, configured to perform a method comprising a mutual authentication with a trusted authentication service, AS, the authentication involving sending to AS authentication information for authenticating D, and receiving from AS authentication information for authenticating AS and creating a secure cryptographic session key using authentication parameters (AP; AP′) resulting from the authentication and a cryptographic key (K_{CDU}; K_{GDU}) associated with D and known to AS; and using the session key (K_{SU}; K_{GSU}) to protect subsequent actual data communication between D and one or more second nodes, C, of the network (NW);
one or more devices, C configured to perform a method comprising verifying the validity of a second cryptographic signature, S_{APC}, using K_{CDU} and ID_{C}; and when S_{APC} is found to be valid and the authentication result, Rslt, contained in the received AP is True, deriving the session key K_{SU} using K_{CDU} and the authentication parameters (AP) contained in T_{CDU} as follows: K_{SU}=HMAC_{KCDU} (ID_{C}∥ID_{D}∥L) with label L=U∥ID_{G}∥ID_{AS}∥Cnt∥R_{D}∥R_{AS}∥Rslt, where Rslt is True or False and indicates the result of the mutual authentication between D and AS; and
an authentication system acting as the authentication service, AS, in the network and configured to perform a method comprising performing a mutual authentication with a device, D, the authentication involving receiving from D authentication information for authenticating D to AS, and sending authentication information for authenticating AS to D; registering one or more second nodes, C, of the network and communicating to each of them a respective use-case-specific and client-specific client key (K_{CDU}); sharing one or more authentication parameters AP used in the authentication with each one of those second nodes, C, which are, as a result of a successful registration with AS, allowed to communicate with D;
wherein D, C and AS are collectively designed to interact in their respective roles according to the method of claim 14 to create a symmetric session key for protecting a use-case-specific communication between D and C over the network.
